(19) United States
(12) Patent Application Publication
(10) Pub. No.: US 2010/0074371 A1
(43) Pub. Date: Mar. 25, 2010

(54) Ultra narrow band frequency selectior for zero point modulated carrier

(76) Inventor: Donald Lee West, Winchester, KY (US)

Correspondence Address: Donald L. West, 3060 Pine Ridge Rd., Winchester, KY, 40391, US

(21) Appl. No.: 12/584,532

(22) Filed: Sep. 8, 2009

Related U.S. Application Data
(60) Provisional application No. 61/194,006, filed on Sep. 24, 2008.

(51) Int. Cl. H04L 27/00

(52) U.S. Cl. 375/316

(57) ABSTRACT

This invention claims a novel radio frequency receiver system for selecting a digitally modulated carrier frequency, and more specifically a Zero Point, amplitude Modulated (ZPM) carrier frequency. ZPM modulation does not create side-band frequencies, thus allowing individual carriers to be very closely spaced. Traditional methods of frequency selection utilize resonant tuning circuits in the antenna circuit and following amplifier circuits. Resonant tuning circuits are the assemblage of inductors and capacitors that are subject to parasitic oscillations, harmonic oscillations, as well as environmental effects. While modern technology has sufficiently overcome these detriments for traditional radio communication, ZPM theory desires to tune to a single frequency carrier with only one cycle of difference between carriers. Obvious to those skilled in the art, this requires a non-traditional method. For ZPM carriers, all signal-handling circuits must be non or insignificantly reactive and process the signal in linear fashion throughout the receiver signal path. This invention accomplishes the required functions by a unique combination of standard integrated circuits and circuit components.

This application claims priority to and benefit of U.S. Provisional Patent Application Ser. No. 61/194,006, filed Sep. 24, 2008 entitled “Ultra Narrow Band Frequency Selector for Zero Point Modulated Carrier.”

### FIELD OF THE INVENTION

The primary importance of Zero Point Modulation (ZPM) is that, in theory no side-band energy occurs, and in practice no significant side-band energy occurs. This radical diversion from all current modulation schemes provides a comparatively unlimited number of communication channels in the radio frequency spectrum. Digital data is recovered from a specifically selected electromagnetic carrier frequency whereas each half or full wave of the carrier, beginning nominally at 0 degrees and ending nominally at 180 or 360 degrees of phase angle, may define a digital bit. Each half or full wave can represent, at least, a 0 or 1 as dictated by a specific digital data format. This implies not only many more channels per unit of spectrum, but more bits per unit time. For example; a 400 MHz carrier frequency would have an 800 Mbit/sec. data rate.

A means of receiving an information-bearing electromagnetic signal whereby the information is presented to the carrier as ZPM digitally encoded data, requires a method unlike any traditional modulation scheme. Closely spaced, adjacent radio frequency stations or channels allowed by this method create a challenge to select and maintain reception. Modern techniques utilize the Phase Lock Loop (PLL) principle that compares the frequency of a Voltage Controlled Oscillator (VCO) to the frequency of an incoming carrier. The VCO is adjusted, by feedback methods, to maintain a constant phase relation between the carrier and VCO frequencies. Simultaneous comparison of the amplitude difference of the VCO frequency and incoming carrier frequency allows the digital information to be extracted. However, other methods of demodulation are available.

Digital communication channels offer the ability to imbed a Carrier frequency IDentification (CID) code and thus, allow a digital processor to recognize a precise frequency. Once located, the receiver will lock onto the frequency being requested. Since the encoded frequency was referenced to an atomic clock at the transmitter side, that same accuracy is then available to the receiver's processor for control of the VCO frequency on the receiverside. A normal characteristic of PLL modules is that an output voltage representing the phase difference of the incoming carrier frequency and the VCO frequency is generated. For example this voltage may be zero when the phase difference is zero and proceed to a voltage value representing a given phase angle difference. This is a fundamental aspect of this invention.

This voltage representing the phase difference between the VCO and carrier frequency is used to control the gain of a signal amplifier. The gain will be at maximum when the phase difference is zero. The gain will decrease with increasing phase difference and can be reduced by any predetermined amount of phase angle difference. A representative number could be −30 db at greater than plus or minus 90 degrees phase difference between the carrier and oscillator frequencies. All other frequencies above or below the selected frequency are rejected, thus we have created a single frequency selector device for a given frequency.

### BACKGROUND OF THE INVENTION

All presently used methods of superimposing information upon a pure sine wave (modulation) corrupts the purity of the sine wave and thereby creates additional frequency content above and below the primary sine wave frequency. In terms of the art this primary frequency is called the “carrier” frequency. Extraneous, associated frequencies are termed side-band frequencies. Currently, throughout the expanse of the radio frequency spectrum, the many classes, types of usage and side-band allowances dictate the minimum frequency space that must be allowed between adjacent carrier frequencies to prevent interference of adjacent channels.

Present amplitude modulated (AM), frequency modulated (FM), and phase modulated (PM) electromagnetic signals create significant side-band energy and therefore occupy frequency intervals above and below the basic carrier frequency. Since the upper and lower side-band each contains the same information one of the two can be discarded. This is referred to in the art as “single side band” modulation.

The required frequency bandwidth for a given channel is proportional to the modulating frequency for AM, and the amplitude of the modulating frequency for FM. Inherently, a large amount of the available frequency spectrum is occupied by side-band energy. This is especially true for Television and FM radio. This wasteful use of the available spectrum has produced extreme methods to satisfy the world's needs for atmospheric communication pathways. However, the extremely high frequencies in the multi GHz range have severe limitations on transmission efficiency and quality.

### SUMMARY OF INVENTION

Zero Point Modulation (ZPM) is a means of imposing digital information upon a sine wave carrier frequency in a manner that does not create side-band energy normally associated with all other known modulation methods. The importance of this concept is that it allows many more carrier frequencies for a given portion of the electromagnetic spectrum, and thus a more efficient use of an increasingly limited commodity

An object of the present invention is to provide a receiver circuit designed to locate and lock onto a specifically encoded carrier frequency and to recover the information impressed thereon. The recent surge of wireless technology, associated gadgetry, global communication, etc., has utilized the atmospheric electromagnetic frequency spectrum to near maximum. Zero Point Modulation allows all current radio wave traffic to be accommodated by a mere portion of current spectrum usage.

The actual amount is dictated by transmitter and receiver system design. Normally, circuit component drift and electromagnetic noise interference requires elaborate methods to compensate for these and other degenerative effects. This receiver system invention is designed to take advantage of repetitive digital identification of discrete frequencies in real-time to maintain signal continuity and integrity.

Another important aspect of receiving this form of modulation is that linear circuitry must be used throughout the signal path. Traditional tuning and frequency selection is accomplished by reactive components such as capacitors and inductors arranged as resonant frequency circuit elements. These tuned circuits in the antenna and subsequent amplifier circuits allow high amplification of a narrow band of frequencies near the carrier of interest. Unfortunately these reactive component circuits distort ZPM signals beyond usefulness. Therefore a novel solution is described herein and herewith to circumvent these limitations.

Although limited to a relatively narrow band, the ZPM approach may encompass 250 information channels. For example, at 100 MHz with 50 channels separated by 2 cycles per channel, the amplifier would be limited to a band from 100,000,000 Hz to 100,000,500 Hz. Amplifier gain will be rolled off above and below these limits to reduce interference from most sources of non-interest. The antenna current is directed to the input of a limited frequency band, impedance matching amplifier, followed by a controllable gain, linear amplifier. The amplifier gain is partially controlled by a direct current (dc) voltage derived from the signal strength at the output of the amplifier, generally termed automatic gain control (agc). The novelty of this invention is that the portion of the gain control voltage which is derived from the phase locked loop circuit, such that the amplifier gain will be maximized only when the VCO and incoming signal are locked in phase, serves as a linear filter and frequency selection device.

### BRIEF DESCRIPTION OF DRAWINGS

The included drawings are specific representations of the present invention and together with the DETAILED DESCRIPTION allow persons skilled in the art, to practice the teaching of this invention.

FIG. 1 is a block diagram of major receiver components with interconnecting lines to indicate the flow of signals, digital data and control voltages.

FIG. 2 is a collection of representative waveforms. 2A is a typical sine wave carrier frequency having no impressed data. FIGS. 2B and 2C are graphical representations of modulated carriers that display specific characteristics of Zero Point Modulation (ZPM). FIG. 2A is indicative of 1 bit per half wave, zero point modulated waveform, and 2B is indicative of 1 bit per full wave, zero point modulated waveform.

### DETAILED DESCRIPTION OF PREFERRED EMBODIMENTS

As with all radio receivers, an antenna converts electromagnetic waves to minute electrical currents that must be sorted and magnified such that only one information channel of choice is made recognizable. This invention does so by this unique arrangement of known components. The first being an antenna, is connected to an impedance matching amplifier that must convert microamperes×MΩ to microamperes×Ω. An overall power gain of 10 db is reasonable for this amplifier. This impedance matching amplifier is followed by a controllable gain amplifier with approximately 30 db gain control range. Automatic gain control (agc) of conventional radio receivers is used to maintain a constant signal level at the amplifier output for a given range of input signal level. This invention requires a combination of conventional agc. and an additional control means derived from a Phase Locked Loop (PLL) circuit.

This unique control means requires use of the “lock-in amplifier” principle, which is now a widely accepted and understood. The lock-in amplifier concept utilizes a PLL circuit that compares the frequency of a Voltage Controlled Oscillator (VCO) to an incoming signal of the same frequency. Any difference in frequency or phase between the two frequencies is considered to be frequency or phase error correction data. Using this phase error data, a suitable feedback arrangement tends to keep the phase difference between the compared frequencies to a minimum. A change of either frequency will produce a feedback error signal that will be continuously minimized, thereby “locking” the frequencies and phase to an insignificant difference. For ZPM the phase error signal will be used to lock the receiver to the target frequency.

Typically, a direct current (dc) voltage applied to its frequency control input determines the frequency of a VCO. Using a digital to analog converter (DAC) as the source for the dc control voltage of the VCO allows its frequency to be controlled by a digitally encoded signal. The voltage value code stored in a parallel output register can be minutely increased or decreased as dictated by the PLL feedback error voltage. Primarily this stored digital value is derived from the Carrier frequency Identification (CID) code. Once phase lock is attained the new, more precise digital value will be stored. Thus, momentary interruptions of incoming signal will not cause a loss of phase lock.

The Gain Control Module is an electronic proportioning arrangement with two control sources. One control source is the agc voltage mentioned earlier and the other is a processor controlled voltage that represents the phase difference between the oscillator and carrier frequencies. A specific voltage will indicate zero phase difference. A shift of phase, either positive or negative, will produce an error voltage. If the phase difference exceeds a preset amount the error voltage will exceed a threshold that will initiate a switch function in the Gain Control Module. The switch applies a voltage to the amplifier gain control input such that the amplifier gain reduces to an amount that no signal passes through. If the threshold voltage represents a phase shift of, for example, plus and minus 90 degrees from a selected frequency, the receiver acts as a single frequency selection device.

Entering a CID code or a reset command deactivates the switch. Processor (4) holds the voltage on (4a) to a level that allows the error correction process to bring the phase relation of the original or a different selected channel within the threshold limits.

Every transmitted channel frequency of a ZPM channel has a CID code. A receiver may have an assigned CID code for personal applications and/or selectable CID codes for commercial, network, emergency, etc. connections. To access a specific communication channel, the receiver powers up on the CID code that would provide the correct frequency from the VCO. Minor adjustments of the stored VCO codes may be required due to temperature effects. This will automatically occur as a result of the error correction process.

Control codes will identify the path for the incoming data. The CID code will be inserted whenever a data gap of sufficient length occurs and will be repeated at regular intervals. By this means channel loss will be automatically detected and corrected. Once the receiver is locked onto an identified frequency and the phase is matched, the receiver VCO is as accurate as the atomic clock that controls the transmitted signals. Thus an extremely accurate time base is established for telephones (both mobile and stationary), Internet, and any other bi-directional implementations.

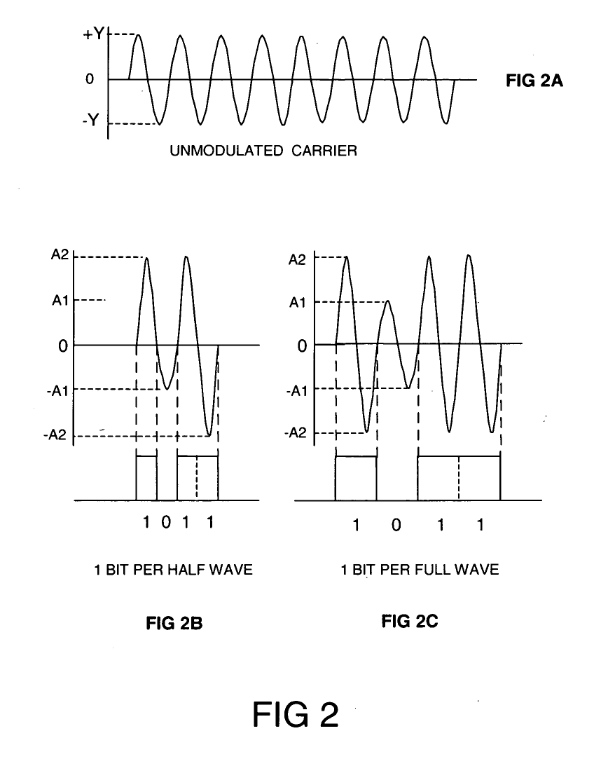

The simplest form of amplitude demodulation, where a PLL process is utilized, is to algebraically subtract the VCO amplitude from the signal amplitude. The difference is then representative of the modulating data. This method is satisfactory for single level modulation as depicted in FIG. 2. Since ZPM offers the possibility of increasing data throughput by additionally assigning different digital values to multiple levels of each full or half wave, a more complex demodulation process is indicated. Since many demodulator schemes are part and parcel to communication art and science, the demodulator method will not be claimed herein.

Inherent to Zero Point Modulation (ZPM) is that the digital data rate must be synchronized to the carrier frequency. Most applications will be bi-directional and therefore a return digital data path is necessary. Just as the input signal, the outgoing signal needs to be sequentially organized and applied to a single carrier frequency. The frequency can be generated by a VCO and controlled by a DAC, which receives its digital input from the processor. Because the processor calibrates in real time to incoming frequencies that have atomic clock accuracy, the processor controlled outgoing carrier frequencies will have the same degree of accuracy. High-speed data links also offer the possibility to transmit and receive on the same frequency by the method of antenna switching. This method is well known by those skilled in communications art.

The processor will sort and distribute data to the proper applications such as phone, television, Internet, etc. Portable transceivers using ZPM in cellular telephone applications that are connected by wide area networks can use network protocols similar to those in current use. However, the frequency identification code will greatly alleviate receiver design and construction complications that are traditionally required for environmental and thermal effects.

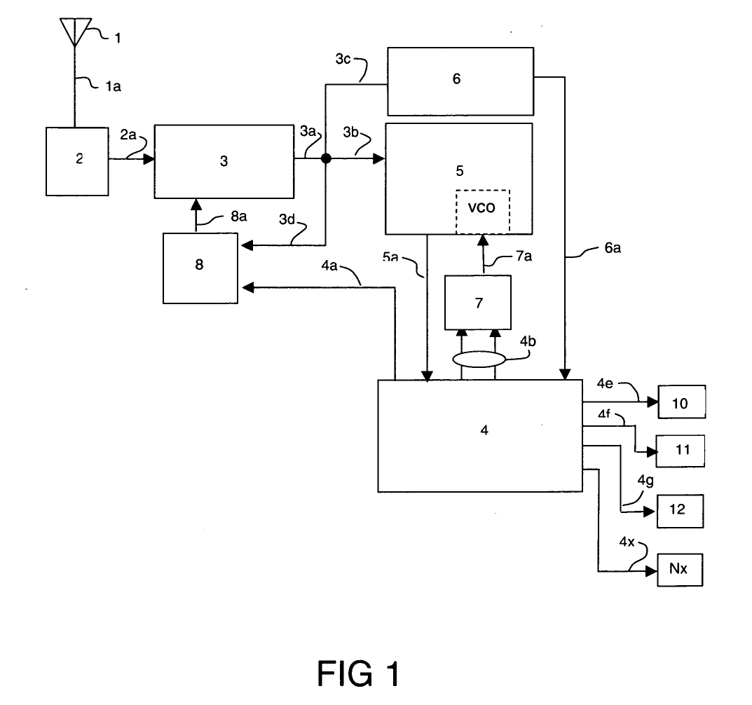

Referring to FIG. 1, Impedance Matching Amplifier (2) receives its input from Antenna (1) by conductor (1a). The amplified signal from Amplifier (2) is fed, via. (2a), to the input of Controllable Gain Amplifier (3). Output (3a) of Amplifier (3) is directed to Phase Locked Loop circuit (5) by conductor (3b). Output of Amplifier (3) is also directed to Demodulator (6) via (3c), and to Gain Control Circuit (8), via (3d). Demodulator (6) extracts the digital data stream and sends it to Processor (4) via (6a). Processor (4) acts on control codes and routes data accordingly. One part of the data is the Carrier frequency IDentification (CID) code that is processed to verify the control voltage for the Voltage Controlled Oscillator (VCO) of the Phase Locked Loop (PLL) module (5) (VCOs are now commonly integrated into PLL Modules.) The dc control voltage for the VCO is derived by Digital to Analog Converter DAC (7) and delivered by (7a) to VCO input of PLL module (5). DAC (7) receives its digital data from Processor (4) as parallel data bits through cable (4b.) PLL (5) receives the channel signal from the output of Controllable Gain Amplifier (3) output via (3b) PLL (5) circuit compares this incoming channel carrier frequency to the VCO frequency and develops dc voltage (5a) that represents the phase relation between said frequencies. Processor (4) utilizes dc voltage (5a) to maintain nearly zero phase difference between said frequencies. Routing (5a) signal through Processor (4) to the Gain Control Module (8), allows processor controllable options. One option is response time of the error correction signal. Another is the degree of acceptable phase angle difference and yet another is the channel frequency capture range. These options can be programmed to automatically cope with signal loss for various reasons.

As the voltage of (5a) approaches its value that represents zero phase shift between said frequencies, amplifier (3) approaches its maximum gain. As amplifier (3) gain increases, its gain is limited by the AGC function of (3d) to maintain proper signal amplitude at output 3a of amplifier (3). The alternate options of processor output, (4a), can give AGC input (3d), full control of the gain of amplifier (3). This mode would support search requirements imposed by severe environmental conditions or signal loss of portable applications.

What is claimed is:

1) In combination, a unique radio wave receiver system for selecting a digitally modulated carrier frequency having essentially zero band width.

2) The method of claim 1 whereas a controllable gain signal amplifier is used.

3) The invention of claim 1 whereas each carrier frequency has a Channel Frequency Identification Code as a portion of the data stream.

4) The invention of claim 1 whereas a digital processor analyzes the digital data stream.

5) The invention of claim 1 whereas an oscillator's frequency is controlled by said processor of claim 4.

6) The invention of claim 1 whereas said digital processor of claim 4 adjusts said oscillator frequency of claim 5 to a specified channel carrier frequency.

7) The invention of claim 1 whereas a frequency phase comparator device compares said frequency of said oscillator of claim 5 to said carrier frequency.

8) The invention of claim 1 whereas an output of said comparator device of claim 7, is a voltage that is representative of the phase difference between said oscillator frequency and said carrier frequency whereas:
a) said oscillator frequency is controlled by feedback error reduction means.
b) said feedback method tends to hold said comparator output voltage, to a specific value range.
c) said specific value of said voltage represents a nearly zero phase difference of said oscillator frequency and said carrier frequency.

9) The method of claim 8 whereas amplification of said controllable gain amplifier of claim 2 is determined by said comparator output voltage whereas:
a) said amplifier gain is maximum at said specific comparator output voltage.
b) said amplifier gain decreases at any voltage other than said specific comparator output voltage.
c) a relative shift of said oscillator frequency and said carrier frequency reduces the gain of said amplifier.
d) a relative shift of said oscillator frequency and said carrier frequency greater than a specified phase difference angle above or below zero phase difference, reduces said amplifier gain to a pre-determinable minimum value.

10) The invention of claim 1 whereby the claims 2 through 9, select a single specified carrier frequency and reject all other frequencies by reducing said amplifier gain.
